(19) United States
(12) Patent Application Publication
(10) Pub. No.: US 2015/0313329 A1
(43) Pub. Date: Nov. 5, 2015

(54) Proximity-Activated and Rechargeable Illuminated Jewelry

(71) Applicant: William Flanery, Largo, FL (US)

(72) Inventor: William Flanery, Largo, FL (US)

(21) Appl. No.: 14/700,405

(22) Filed: Apr. 30, 2015

Related U.S. Application Data
(60) Provisional application No. 61/987,693, filed on May 2, 2014.

(51) Int. Cl. A44C 15/00; A44C 9/00; F21V 23/04; F21V 23/00; F21V 33/00; F21L 4/08

(52) U.S. Cl. CPC A44C 15/0015; F21V 33/0008; F21L 4/08; F21V 23/0471; F21V 23/009; A44C 9/00; F21Y 2101/02

(57) ABSTRACT

The present invention is a combination of a ring or other jewelry using a magnetic switch to activate a light source and a complementary magnetic ring which activates the magnetic switch when in close proximity. Energy storage in the ring may be a rechargeable battery, a capacitor or any combination of batteries and capacitors. The light source is preferably a LED (light emitting diode), although other sources, such as a laser diode, electroluminescent material or a lamp, can be used

### FIELD OF THE INVENTION

The present invention relates to a system of electronically illuminated jewelry using a proximity sensor to activate illumination in a first piece of jewelry.

### BACKGROUND OF THE INVENTION

Jewelry with means for illumination is known. Among the means to activate are batteries, mechanical and electrical switches, and motion activated switches. The present invention is an improvement in electrically illuminated jewelry because of the use of a proximity sensor to initiate illumination.

It is an object of the present invention to provide energy collection, energy storage and illumination in a wedding ring or other fine jewelry whereby the illumination is initiated by close proximity to a complementary magnetic ring.

### SUMMARY OF THE INVENTION

The general purpose of the present invention, which will be described subsequently in greater detail, is to provide a new system for the activation of illumination in jewelry that is suitable to be constantly worn.

The invention is combination of a ring or other jewelry using a magnetic switch to illuminate and a complementary magnetic ring which activates the magnetic switch when in close proximity. While the preferred embodiment incorporates a wedding ring, the system is compatible when applied to other jewelry and ornamentation, such as ear rings, bracelets, brooches and like items.

Energy storage in the ring may be a rechargeable battery, a capacitor or any combination of batteries and capacitors. The illumination source is preferably a LED (light emitting diode), although other sources, such as a laser diode, electroluminescent material or a lamp, can be used.

The use of energy collection and rechargeable energy storage eliminates the need for replaceable energy storage, which facilitates designing the jewelry to be water resistant. Water resistance allows a piece of jewelry to be worn continuously, even during common tasks such as washing one's hands.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front plan view of a preferred embodiment of a wedding ring.

FIG. 2 is a front cross-sectional view of the preferred embodiment of the ring.

FIG. 3 is a perspective view of the ring illustrating a battery charging circuit and illumination controller on flexible printed circuit material, visible within the transparent epoxy potting compound filling the cavity.

FIG. 4 is an isometric view of a preferred embodiment of a magnetic ring.

FIGS. 5a-c illustrates an alternate embodiment of the wedding ring.

### DETAILED DESCRIPTION OF THE INVENTION

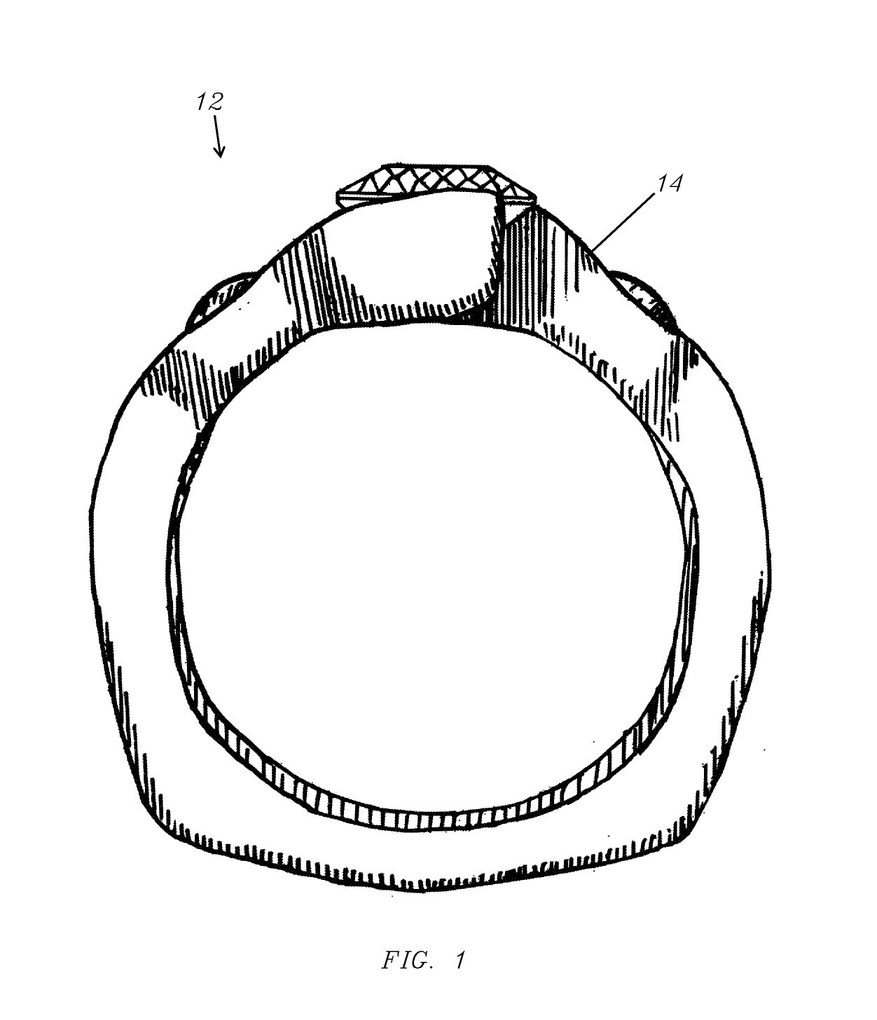

A first embodiment of the invention is illustrated in FIGS. 1-4. The invention comprises a pair of pieces of jewelry and the like. A first piece 12 uses an illumination controller to illuminate when in proximity to a magnetic second piece 40.

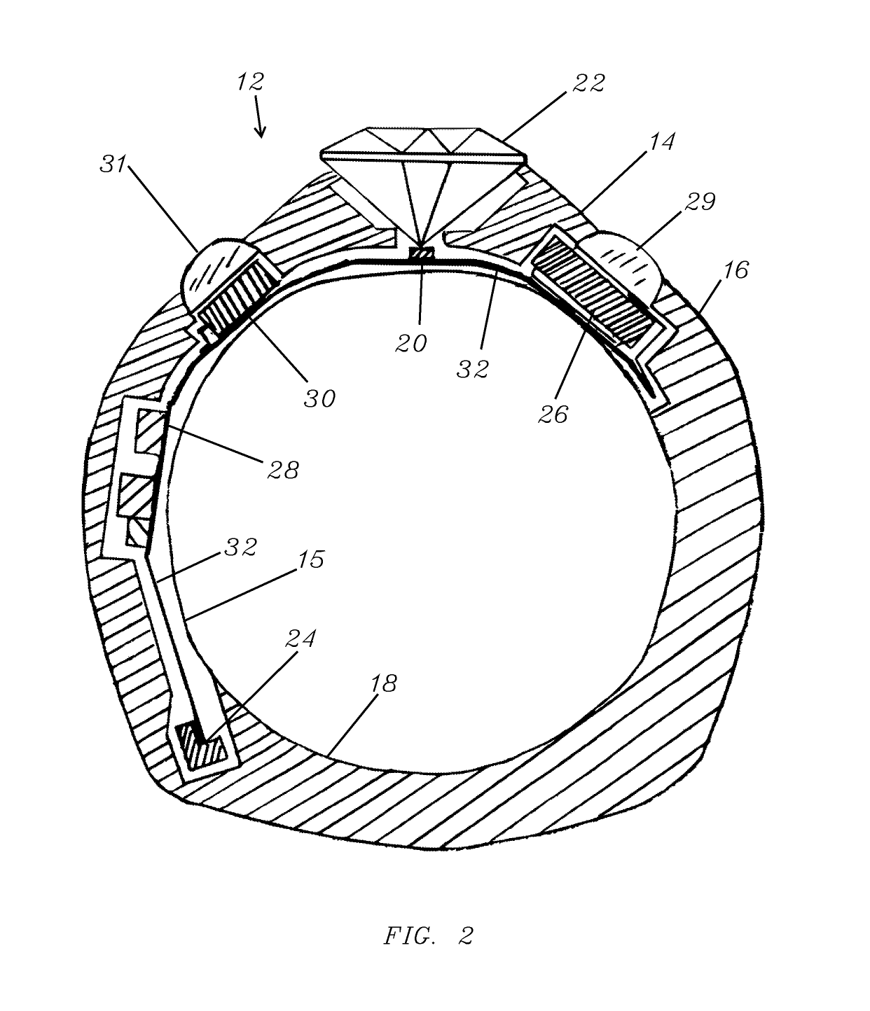

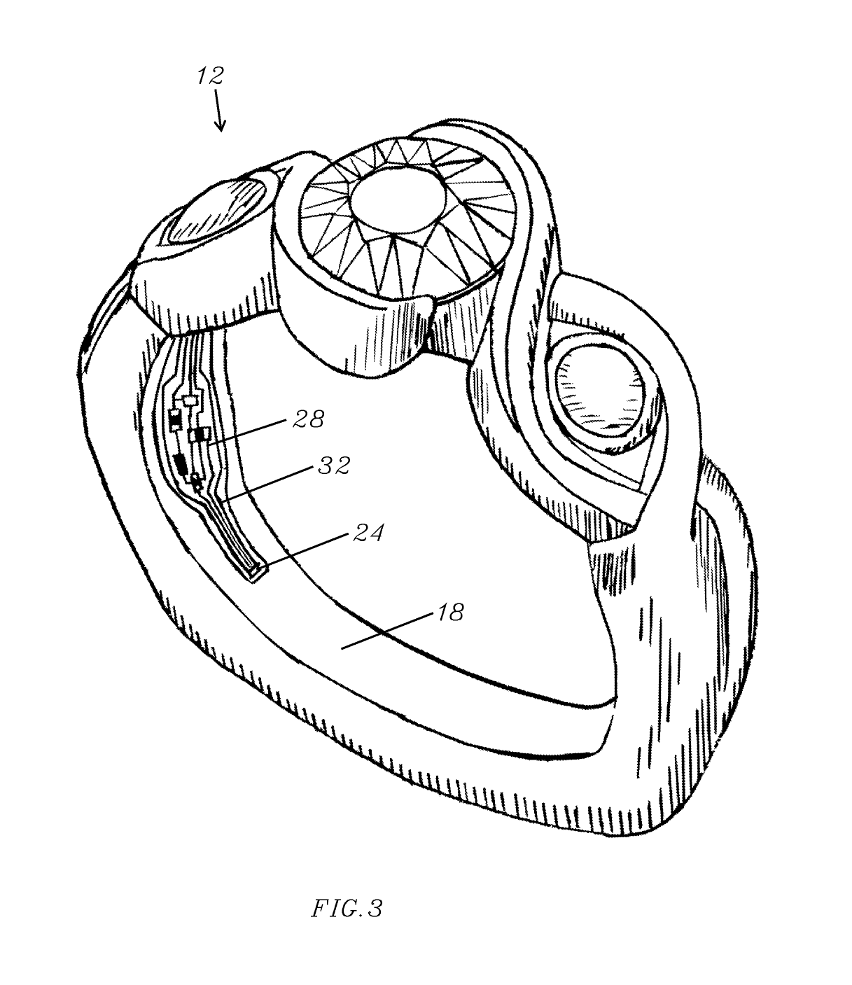

As shown in FIGS. 2-3, a first piece 12 comprises a body 14 having an outer planer surface 16 and an inner planer surface 18, and further has a cavity defined therein. A light source 20, preferably a LED (light emitting diode) is mounted near the cavity below the culet of a primary gem stone 22 mounted within the cavity, and emitting light directly, or by reflection or refraction, into the gem stone. The primary gem stone is normally the largest stone, centrally located and mounted on the top arc of the ring. The light source 20 may also be a lamp, electroluminescent material or laser diode. The term “light” is used broadly to include wavelengths beyond human perception. An example of using non-visible wavelengths is to use ultraviolet to cause a stone to fluoresce, rather than transmitting visible light. It should be recognized that while the illuminated object may be a primary gem stone, surrounding gemstones or other visible materials may be illuminated. Illumination is by direct transmission of light or by fluorescence.

The body 14, and the electronic circuitry and components, can be comprised of water-resistant protective materials, such as potting compound, preferably transparent epoxy, and/or metal inserts.

An illumination controller 24, functioning as a magnetic sensor, preferably a magnetic reed switch, is positioned within the body 14. While the controller 24 is preferably a magnetic reed switch, other modes such as RF oscillation, or more sophisticated systems such a microcontroller controlled circuits utilizing RFID or other detections, are possible. The illumination may be full on/off, dimmed, illumination of one or multiple light sources, or the same or multiple colors. The illumination may be controlled to be active only when the second piece 40 is detected, or for a specific period of time after the second piece is moved away.

An energy storage module for illumination is comprised of a rechargeable battery 26 positioned below a sapphire-glass lens 29. The sapphire-glass lens 29 provides aesthetic symmetry to a functional sapphire-glass-lens 31. The energy storage may also be a capacitor or a combination of batteries and capacitors. Methods for converting available ambient energy into electrical energy for charging the battery 26 include solar, thermal, motion, vibration/acoustic, electromagnetic inductive, and RF (Radio Frequency). The present invention utilizes battery charging circuitry 28 to charge the battery at all times when sufficient ambient illumination is available, and activates its light source automatically when in proximity to the second piece 40.

A solar power interface is provided by a compact photovoltaic panel 30. The sapphire-glass lens 31 provides a light collecting window covering for the photovoltaic panel while obscuring the panel from view. Electrical voltage regulation and conditioning is provided by battery charging circuitry 28. Electrical communication between the various components is facilitated by flexible circuitry 32.

Although the charging system may be designed to harvest power from the environment, it is possible that weather or other factors may hinder the availability of ambient energy power. Artificial means of supplying power are possible, for example a jewelry case containing a lamp.

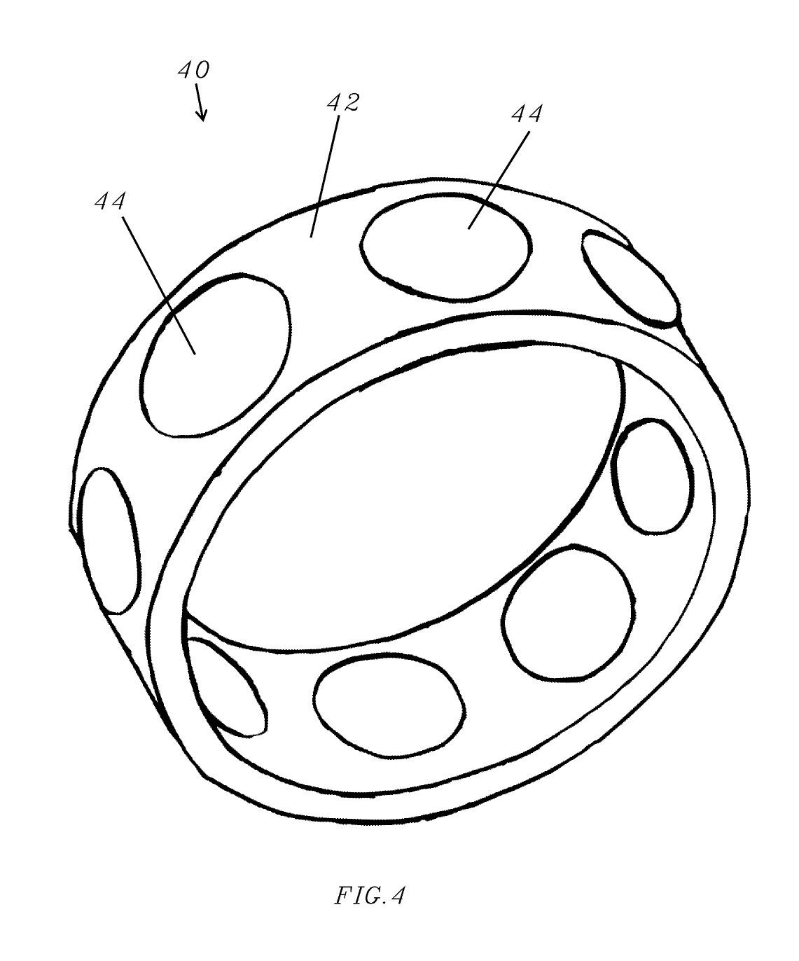

As shown in FIG. 4, the second piece 40 has a body 42 with designed magnetic field orientation integrally formed therein. Preferably, at least one magnet 44 provides the field orientation.

In use, the presence of the magnetic field of the second piece activates the illumination controller of the first piece. Illumination is initiated in the first piece. It is also possible to design both pieces to illuminate and magnetically activate each other. This can be accomplished by orienting each the magnet and the magnet sensor of each piece such that the magnet of each piece does not activate its own sensor, but would activate the corresponding piece in close proximity.

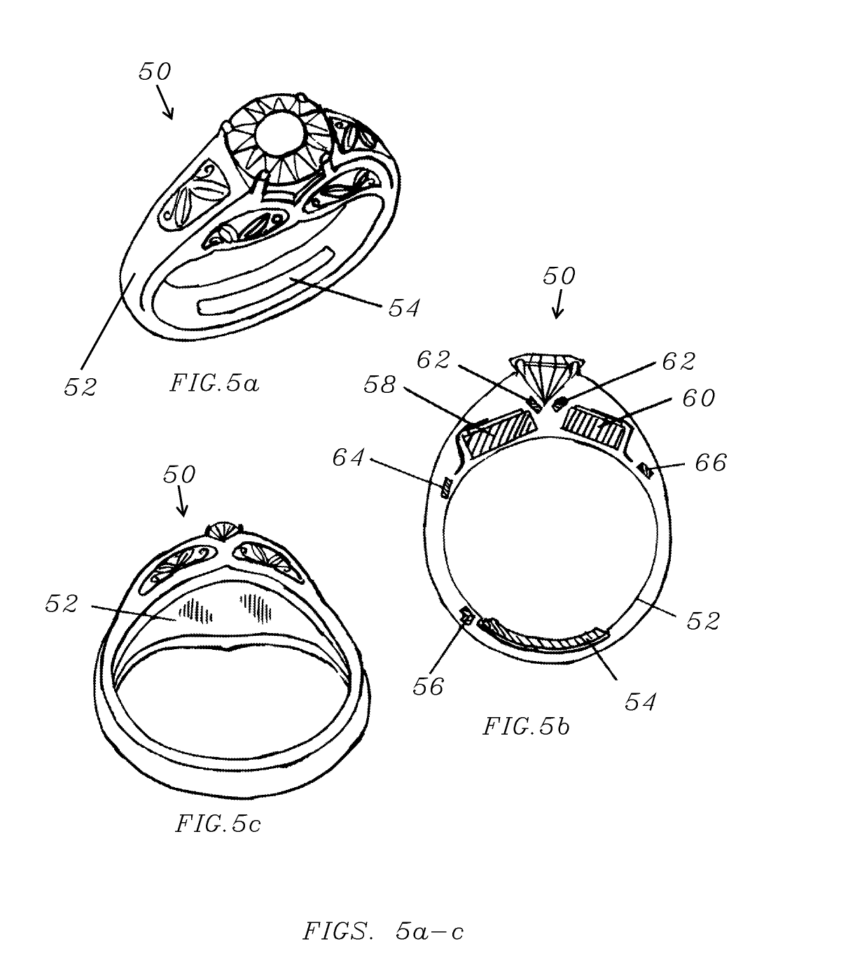

An alternative embodiment of a first piece 50 is shown in FIGS. 5a-c. This embodiment uses direct contact charging of the battery, and not energy harvesting. The piece 50 includes a body 52 shaped as a ring having a first battery contact 54 (either positive or negative), a magnetic sensor 56, a first battery 58, a second battery 60, and LEDs 62 for illumination. A first diode 64 and a second diode 66 are provided to prevent battery draining. The body 52 of the piece 50 is composed of electrically conductive material, preferably metal, to provide a second battery contact to second battery terminals of the batteries.

As stated above, the primary object of the system is to provide a solar-charging engagement or wedding ring that utilizes a magnetic switch to illuminate when in close proximity to a magnetic ring worn by his or her fiancée or spouse. With respect to the above description then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawing are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A proximity-activated illuminated jewelry, comprising in combination:
a first piece having a body with at least one light source mounted therein;
an illumination control mounted in the first piece in communication with, the light source;
an energy supply module mounted in the first piece;
a second piece having a body having a designed magnetic field orientation integrally formed therein; and
whereby in the presence of the magnetic field of the second piece the illumination control is activated.

2. The illuminated jewelry as set forth in claim 1, whereby the energy supply module of the first piece is a rechargeable battery.

3. The illuminated jewelry as set forth in claim 2, whereby the light source of the first piece is a light emitting diode.

4. The illuminated jewelry as set forth in claim 3, further comprising battery charging circuitry.

5. The illuminated jewelry as set forth in claim 4, whereby the illumination controller of the first piece is a magnetic reed switch.

6. The illuminated jewelry as set forth in claim 1, whereby the electronic circuitry and components are made water resistant by use of a potting compound.

7. A proximity-activated illuminated jewelry, comprising in combination:
a first body having an inner surface, an outer surface, and having a cavity defined therein, comprising:
circuitry for electrical communication;
a light source positioned near the cavity;
a gem stone mounted so as to be illuminated by the light source;
an illumination control in communication with the light source;
a battery in communication with the circuitry; and
battery charging circuitry;
a second body having a designed magnetic field orientation integrally formed therein; and
whereby in the presence of the magnetic field of the second body the illumination control is activated.

8. The illuminated jewelry as set forth in claim 7, whereby the first piece further comprises a solar power photovoltaic panel.

9. The illuminated jewelry as set forth in claim 8, whereby the first piece further comprises light collecting optics used to increase the amount of light that reaches the photovoltaic panel.

10. The illuminated jewelry as set forth in claim 7, whereby the first piece further comprises one or more thermal energy harvesting devices and requisite battery charging circuitry.

11. The illuminated jewelry as set forth in claim 7, whereby the first piece further comprises one or more kinetic energy harvesting devices and requisite battery charging circuitry.

12. The illuminated jewelry as set forth in claim 7, whereby the first piece further comprises one or more Radio Frequency energy harvesting devices and requisite battery charging circuitry.

13. A proximity-activated illuminated jewelry, comprising in combination: a first piece comprising:
a body shaped as a ring functioning as a first battery contact;
a second battery contact defined along a portion of the surface of the body;
at least one battery;
at least one light source; and
an illumination control in communication with the light source;
a second body having a designed magnetic field orientation integrally formed therein; and
whereby in the presence of the magnetic field of the second body the illumination control is activated.
